(19) United States
(12) Patent Application Publication
(10) Pub. No.: US 2009/0189881 A1
(43) Pub. Date: Jul. 30, 2009

(54) Display device

(75) Inventors: Yoshihisa Ooishi, Yokohama (JP); Junichi Maruyama, Yokohama (JP); Takashi Shoji, Fujisawa (JP); Kikuo Ono, Mobara (JP)

Correspondence Address: REED SMITH LLP, Suite 1400, 3110 Fairview Park Drive, Falls Church, VA, 22042, US

(73) Assignee: Hitachi Displays, Ltd.

(21) Appl. No.: 12/314,188

(22) Filed: Dec. 5, 2008

(30) Foreign Application Priority Data
Jan. 25, 2008 (JP) 2008-014384

(51) Int. Cl. G09G 5/00; G09G 3/20

(52) U.S. Cl. 345/211; 345/55

(57) ABSTRACT

In the case where one horizontal period becomes shorter as a high frame rate drive of 120 Hz or higher is introduced or the resolution is increased, the time for the writing in of a voltage to the holding capacitor of pixels cannot be sufficiently secured.

Two data lines are provided to an electrode for supplying a data voltage to a group of pixels in the vertical direction in such a manner that one data line of the two data lines is connected to one of the two pixels in the vertical direction and the other data line of the two data lines is connected to the other pixel, while one gate line shared by two horizontal lines formed of two pixels, to which different data lines adjacent in the vertical direction are connected, is provided and connected to the electrode for controlling the turning ON/OFF, the data line driving portion has outputs of which the number is two times greater than the number of horizontal pixels in order to make it possible to apply a voltage simultaneously to the pixels for two horizontal lines, and the gate line driving portion has outputs of which the number if ½ the number of vertical pixels by connecting one gate line to two horizontal lines.

### BACKGROUND OF THE INVENTION

The present invention relates to an active matrix type display device and a method for driving the same, and in particular, to a liquid crystal display or the like.

Active matrix type liquid crystal display devices are characterized by being thin and highly precise and having low power consumption, and thus, used as display devices for thin televisions and the like.

FIG. 16(a) shows an example of the configuration of a conventional liquid crystal display device. The conventional liquid crystal display device is formed of a liquid crystal panel 1600, a data line driving portion 1601, a gate line driving portion 1602 and a timing controlling portion 1603. The liquid crystal panel 1600 is provided with active elements, such as thin film transistors (hereinafter referred to as TFT's) in pixels 1604 which are aligned in a matrix of n×m in a plane. FIG. 17 is a diagram showing the alignment of the pixels 1604 in detail. Electrodes for controlling the turning ON/OFF of the respective active elements are connected to the same gate line 1605 in the horizontal direction, and the electrodes for supplying a data voltage are connected to the same data line 1606 in the vertical direction in the configuration. m and n are integers of 1 or higher and indicate the resolution of the panel, and in the case of a panel formed of sub-pixels in an RGB stripe alignment, where the number of horizontal pixels 1920×the number of vertical pixels 1080, for example, n=1920×3=5760 and m=1080.

Next, FIG. 16(d) shows an example of the configuration of the timing controlling portion 1603. The timing controlling portion 1603 is formed of a data processing portion 1628, a timing generating portion 1629 and a signal transmitting portion 1630. Display data 1631 and a timing signal 1632 are inputted from an external system so that the display data 1631 is transferred from the top of the display screen in sequence, and a signal process (for example an overdrive process or a process for adjusting the gradation properties) is carried out in the data processing portion 1628, taking the properties and configuration of the liquid crystal into account, so that display data 1631′ to be converted to a corresponding voltage in the data line driving portion 1601 is generated. The timing signal 1632 generates the respective control signals 1633 for the data line driving portion 1601 and the gate line driving portion 1602 in the timing generating portion 1629. The display data 1631′ and the control signals 1633 are converted to a signal 1614 in a transfer system for the data line driving portion 1601 and a signal 1624 in a transfer system for the gate line driving portion 1602 by the signal transferring portion 1630 and outputted.

The data line driving portion 1601 is formed of a number of data line driving circuits 1607, and applies a voltage in accordance with the gradation level of the display data to n data lines S1, S2 . . . Sn. FIG. 16(b) shows an example of the configuration of the data line driving circuit 1607. In the data line driving circuit 1607, display data and a timing signal (1614) are received by the signal receiving portion 1609, a trigger signal 1616 and a horizontal starting signal 1617 in sync with the transfer of the display data are taken into a shift register 1610, and thus, a group of timing signals 1618 for taking the display data 1615 into a take-in latch A (1611) is generated. The group of timing signals 1618 allows display data 1615 which is transferred in sequence to be taken into the take-in latch A (1611) for one horizon, and the timing signal 1619, which has completed storage of display data for one horizon, allows display data for one horizon to be collectively transferred from the take-in latch A (1611) to the take-in latch B (1612), as well as for it to be converted to a voltage corresponding to the gradation level of the display data in a D/A converting portion 1613. In the D/A converting portion 1613, each data line outputs a voltage for applying a positive voltage or a negative voltage to the liquid crystal following an alternating current signal 1620 for alternating current drive of the liquid crystal. In the case of dot inversion drive, application voltages of different polarities are outputted to adjacent data lines, and the alternating current signal is inverted for each horizontal period and each frame period, so that the polarity of the output to the data lines is inverted and dot inversion drive can be implemented. The period during which a voltage corresponding to one piece of display data is applied to the data line 1606 is one horizontal period, during which the take-in latch B (1612) takes in display data for one horizon to be updated.

The gate line driving portion 1602 is formed of a number of gate line driving circuits 1608 and supplies a voltage for turning ON the TFT's which write the voltage outputted by the data line driving portion 1601 into the pixel electrode connected to a gate line, and supplies a voltage for turning OFF the TFT's which write the other voltage outputted by the data line driving portion 1601 into the electrodes not connected to the gate line.

FIG. 16(c) shows an example of the configuration of the gate line driving circuit 1608. The gate line driving circuit 1608 receives a signal 1624 from the timing controlling portion through a signal receiving portion 1621, takes in a frame start timing signal 1626 and a horizontal timing signal 1625 into a shift register 1622, and generates a group of timing signals 1627 gained by shifting the frame starting signal 1626 for each horizontal timing signal 1625. High signals and low signals in the group of timing signals 1627 outputted by a shift register 1622 are converted to a voltage for turning ON a gate line, and a voltage for turning OFF a gate line, respectively by the level shifter 1623 and outputted to the respective gate lines 1605. The gate line driving circuits 1608 in the configuration scan all of the gate lines from the gate line G1 to the gate line Gm in sequence in order to find the ON voltage. The display data voltage in the corresponding location is applied to a pixel electrode for each horizontal period by the data line driving portion 1601 in accordance with the timing with which the gate line is turned ON for each horizontal period, and thus, one image (one frame) is displayed.

In addition, Patent Document 1 (Japanese Unexamined Patent Publication 2005-165038) describes that pixels in two adjacent lines (for example the first and second row in FIG. 1) are connected to the same gate signal lines (for example G2) in zigzag, and pixels in the next two adjacent rows (for example the second and third row in FIG. 1) in the same column (for example the first column in FIG. 1) are connected to the same gate lines in every two columns (for example the first, third and fifth columns in FIG. 1) and data for pixels is realigned in order to reduce inconsistency in the write-in of voltages with positive and negative polarities through adjustment of the timing with which the gate of a TFT is opened.

Patent Document 2 (Japanese Unexamined Patent Publication 2003-315766) describes that pixels in two adjacent rows are connected to the same gate signal line in zigzag.

Patent Document 3 (Japanese Unexamined Patent Publication 2007-164100) describes that each pixel is formed of four display dots (four colors) in window shape, and a gate line GL is placed so as to pass through the middle portion of the pixel in the direction of the rows and the gates of the switching transistors SW for four display dots are connected to this gate line GL, and thus, the gate wires for the respective switching transistors SW are shorter.

### SUMMARY OF THE INVENTION

In the above described background technology, each horizontal period for scanning the lines is short when the resolution of the panel is high, or in the case of high frame rate driving, where the speed of rewrite of screens is as high as 120 Hz or higher, which is effective for reducing blurring in moving images, and when a sufficient write-in period during which the voltage corresponding to display data is applied to pixel electrodes cannot be secured, a desired voltage cannot be written into pixel electrodes, and there is a risk that the image quality might lower.

An object of the present invention is to provide a display device with high frame rate drive and high resolution, as well as a method where a sufficient period for the writing in of a display signal into pixels can be secured.

According to the present invention, pixels for two adjacent rows in the same column are connected to different data lines and the same gate line. In this case, it is preferable for the number of data lines to be two or more times the number of pixels in the direction of the rows.

In the display panel portion, for example, two data lines are provided to electrodes for supplying a display signal to a group of pixels in one vertical direction, and one of the above described two data lines is connected to one of two pixels in the vertical direction, and the other of the above described two data lines is connected to the other pixel, which is not connected to the above described data line. One gate line shared by two horizontal lines formed of two pixels to which different data lines which are adjacent in the vertical direction are connected is provided and connected to the electrodes for turning ON/OFF the pixels. It is preferable for the number of outputs from the data line driving portion to be two times greater than the number of horizontal pixels, in order for a voltage to be simultaneously applied to pixels for two horizontal lines (chronographically parallel or chronographically overlapping), and it is preferable for the number of outputs from the gate line driving portion to be half of the number of vertical pixels, in order to make connection to one gate line with two horizontal lines. Furthermore, it is preferable for the timing controlling portion to be provided with a line latch, so that the transferred display data for two lines which written simultaneously is converted for the alignment of the data lines, and the voltage applied to the data line driving portion is updated and the lines for the gate line driving portion are scanned for two horizontal periods.

According to the present invention, a sufficient write-in period during which a target display signal is provided to pixel electrodes can be secured in liquid crystal displays with a high frame rate drive of 120 Hz or higher, which is effective in order to reduce blurring of moving images, and with high resolution, and thus, the image quality can be prevented from lowering.

### BRIEF DESCRIPTION OF THE DRAWINGS

These and other features, objects and advantages of the present invention will become more apparent from the following description when taken in conjunction with the accompanying drawings, wherein:

FIG. 1 is a diagram showing the block configuration of the liquid crystal display device according to the first embodiment;

FIG. 2 shows the arrangement of pixels in the first embodiment;

FIG. 3 shows the polarity of voltages applied to respective pixels in the first embodiment;

FIG. 4 is a frame timing chart for the first embodiment;

FIG. 5 is a line timing chart for the first embodiment;

FIG. 6 shows an example of display data transfer in the first embodiment;

FIG. 7 shows the arrangement of pixels in the second embodiment;

FIG. 8 shows the polarity of voltages applied to respective pixels in the second embodiment;

FIG. 9 shows an example of display data transfer in the second embodiment;

FIG. 10 shows the arrangement of pixels in the third embodiment;

FIG. 11 shows the polarity of voltages applied to respective pixels in the third embodiment;

FIG. 12 shows an example of display data transfer in the third embodiment;

FIG. 13 is a diagram showing the block configuration of the liquid crystal display device according to the fourth embodiment;

FIG. 14 is a frame timing chart for the fourth embodiment;

FIG. 15 is a line timing chart for the fourth embodiment;

FIG. 16 is a diagram showing the block configuration of a conventional liquid crystal display device;

FIG. 17 shows the arrangement of pixels according to the prior art;

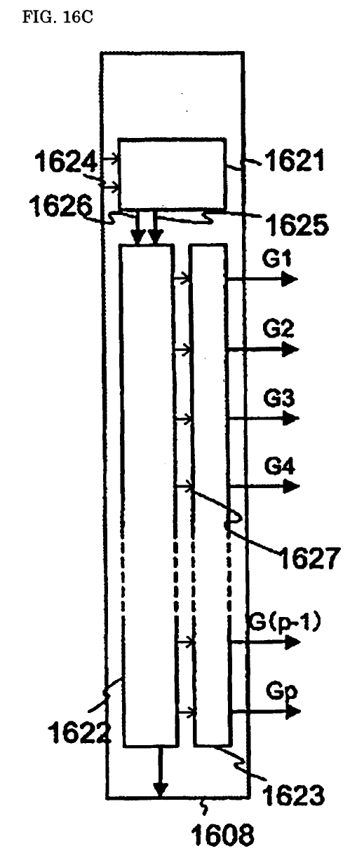

FIG. 18 is a frame timing chart for the prior art;

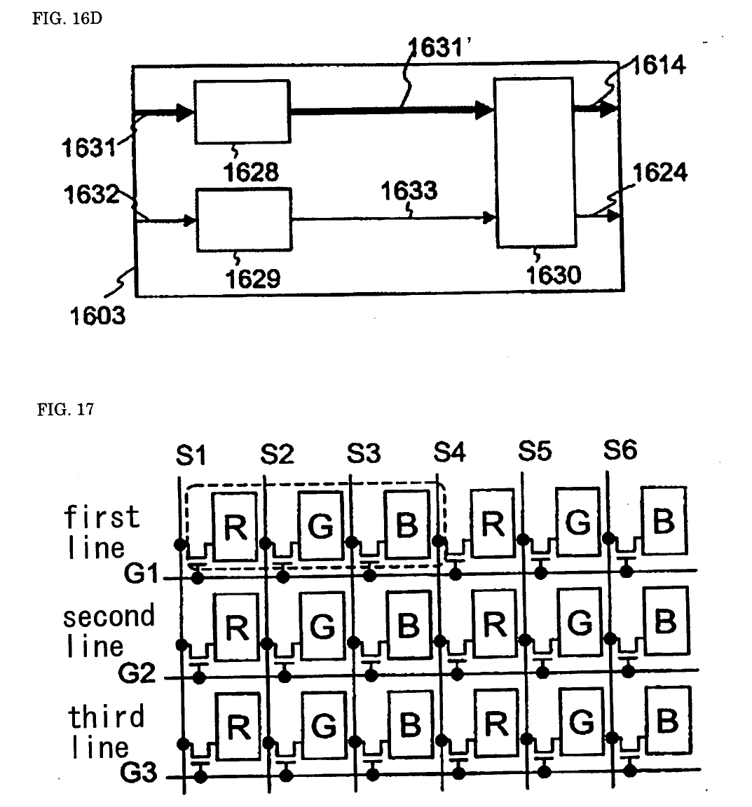

FIG. 19 is a line timing chart for the prior art;

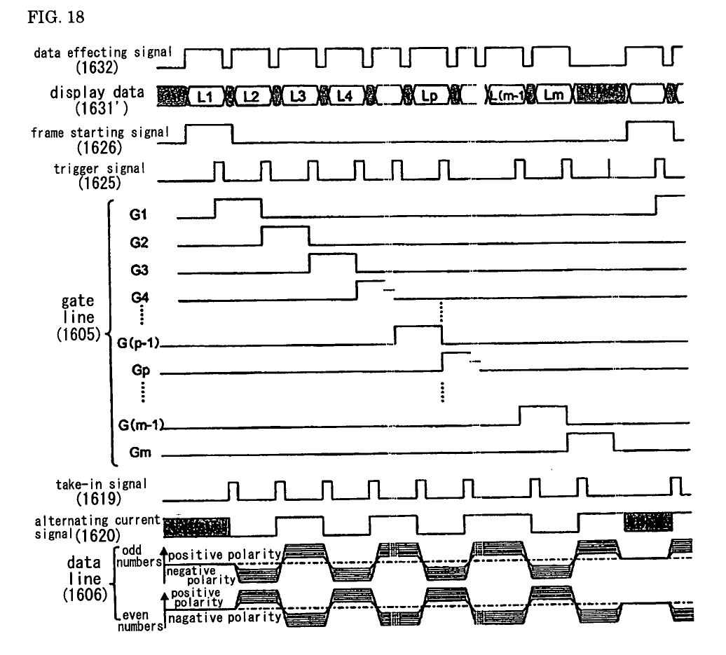

FIG. 20 is an example of conventional display data transfer;

FIG. 21 is a diagram showing the block configuration of the liquid crystal display device according to the fifth embodiment; and

FIG. 22 shows the arrangement of pixels in the fifth embodiment.

### DESCRIPTION OF THE EMBODIMENTS

In the following, the first to fifth embodiments of the present invention are described.

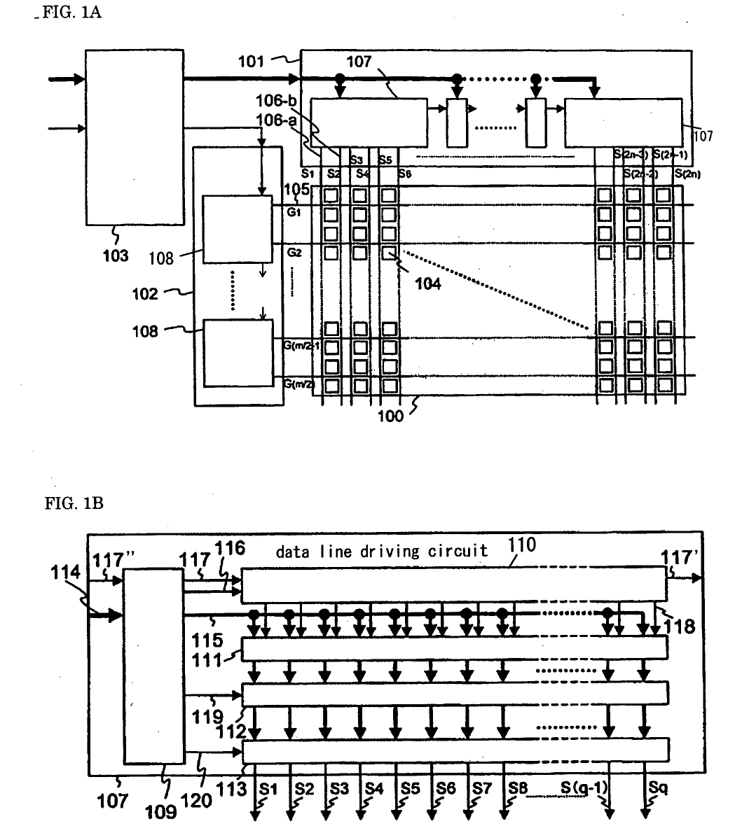

The active matrix type liquid crystal display device and driving method according to the first embodiment of the present invention are described in reference to FIGS. 1 to 5.

FIG. 1(a) is an example of a diagram showing the block configuration of the liquid crystal display device according to the first embodiment of the present invention.

The liquid crystal display device according to the first embodiment is formed of a liquid crystal panel portion 100, a data line driving portion 101, a gate line driving portion 102 and a timing controlling portion 103. The liquid crystal panel portion 100 is provided with active elements, such as TFT's, as liquid crystal pixels 104 provided in a matrix of n×m in a plane.

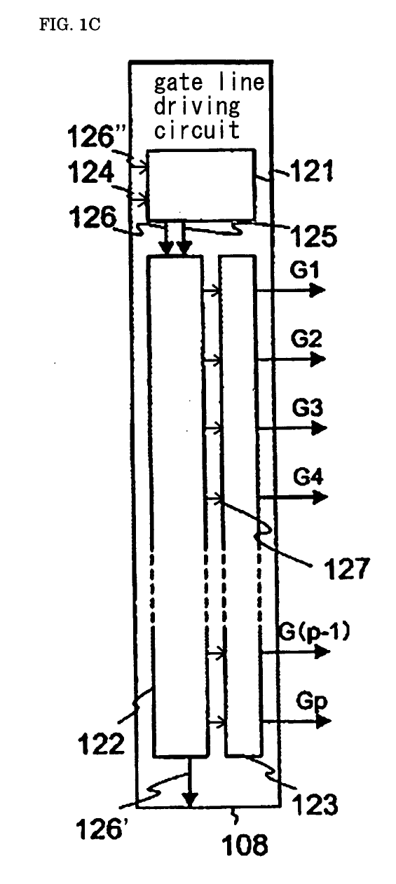

FIG. 2 shows the details of the alignment of pixels. Red (R) pixels, green (G) pixels and blue (B) pixels are respectively aligned in vertical stripes. The electrodes for turning ON/OFF each active element 200 are connected to one gate line 105 shared by pixel groups in two horizontal lines. Two data lines 106 (106-a and 106-b) are provided to one vertical pixel column, and the electrodes for supplying a data voltage (display signal) for two pixels (104-1 and 104-2) provided in the vertical direction and connected to the same gate line G1 are connected to separate data lines (106-a and 106-b). At this time, data lines to which pixels in the same even columns are connected are either adjacent even data lines or odd data lines, and the odd pixel columns are connected to adjacent odd data lines in the case where the even pixel columns are even data lines and adjacent even data lines in the case where the even pixel columns are odd data lines. In the case of FIG. 2, for example, pixels in odd lines (104-1, 104-3, 104-5, 104-7 . . . ) in odd pixel columns (104-1, 104-5) are connected to odd data lines (104-1 is connected to the data line S1, 104-5 is connected to the data line S5) and even pixel columns (104-3, 104-7) are connected to even data lines (104-3 is connected to the data line S4, 104-7 is connected to the data line S8). The pixels in the even lines connected to the same gate line G1 (104-2, 104-4, 104-6, 104-8 . . . in the second line) are connected to a different data line from the pixels in odd lines (104-1, 104-3, 104-5, 104-7 . . . ), and therefore, the odd pixel column (104-2, 104-6) is connected to even data lines (104-2 is connected to the data line S2, 104-6 is connected to the data line S6), and the even pixel columns (104-4, 104-8) are connected to odd data lines (104-4 is connected to the data line S3, 104-8 is connected to the data line S7). In the pixel configuration shown in FIG. 2, dot inversion drive can be implemented with excellent display image quality, with a data line driving circuit IC of conventional dot inversion, simply by inverting the frame period (period for the writing in of a display signal in pixels for one image), without inverting the alternating current signal for the voltage applied to the data line in a horizontal period (period for the writing in of a display signal in pixels for each line). The number of data lines is two times greater than the number of pixels in the horizontal direction (2n), and the number of gate lines becomes ½ times the number of pixels in the vertical direction (m/2). Here, in the case where pixels in three rows or more in the same column are connected to the same gate line, the number of data lines may be 2n or more, or the number of gate lines may be m/2 or less. Here, the horizontal direction (direction of rows) and the vertical direction (direction of columns) may be switched.

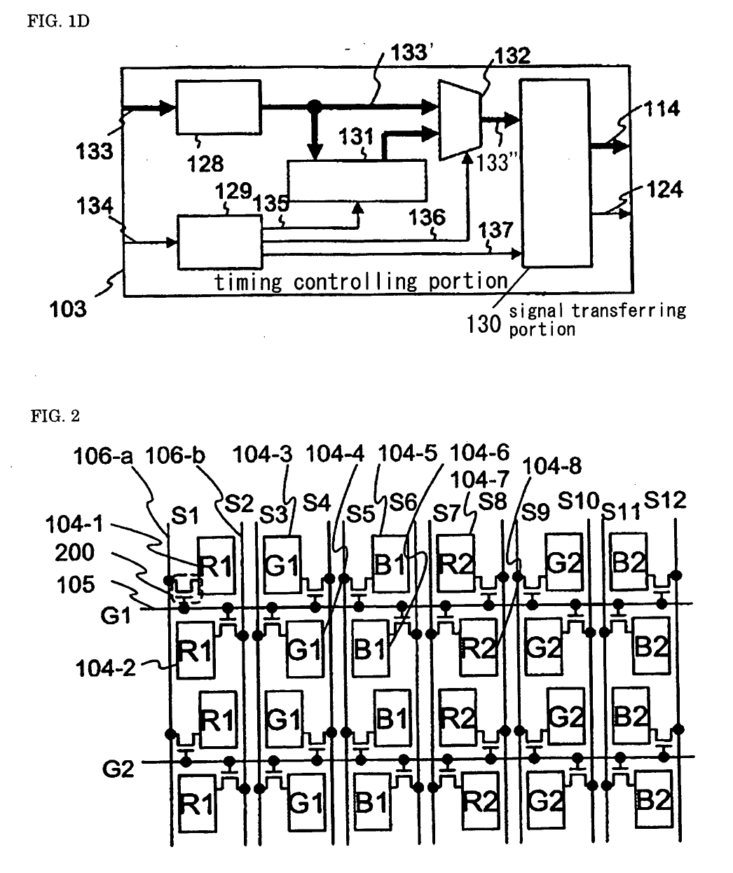

FIG. 3 shows the polarity of the voltages applied to the respective pixels. Here, the polarity of the voltages is referred to as the relative polarity of the voltage applied to pixel electrodes relative to the voltage applied to a counter electrode (shared by a number of pixels) provided so as to face pixel electrodes to which active elements are connected via a liquid crystal layer. In the case where the voltage of a pixel electrode is higher than the voltage of a counter electrode, the polarity is positive, and in the case where the voltage of a pixel electrode is lower than the voltage of a counter electrode, the polarity is negative. In a certain frame, a voltage with positive polarity is applied to odd data lines (S1, S3, S5 . . . ), a voltage with negative polarity is applied to even data lines (S2, S4, S6 . . . ) without inverting the voltage whenever the voltage of the data line is updated, unlike in the prior art, and thus, voltages with the same polarity are applied during the frame period. The data lines connected to two adjacent pixels from above, beneath, left and right, are odd data lines and even data lines. Taking the pixel in the second row, second line as an example, it is connected to S3 and an odd data line. Pixels above and beneath are connected to S4, the pixel on the left is connected to S2, and the pixel on the right is connected to S6, and thus, the adjacent pixels are connected to even data lines, and dot inversion is implemented.

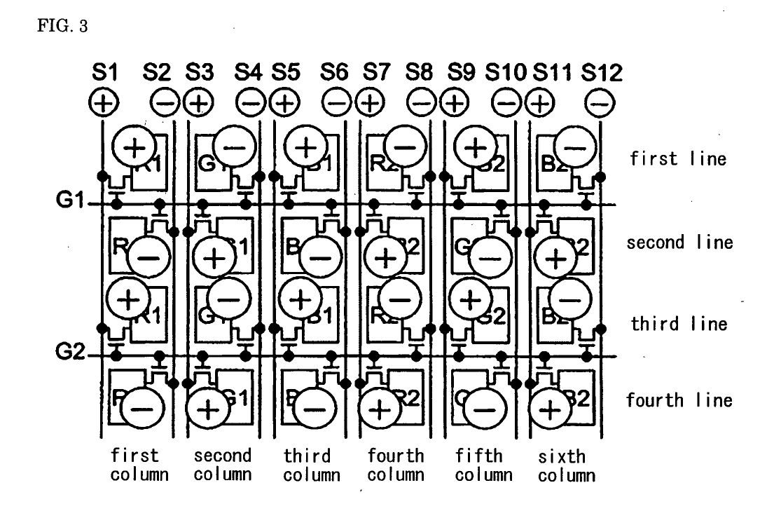

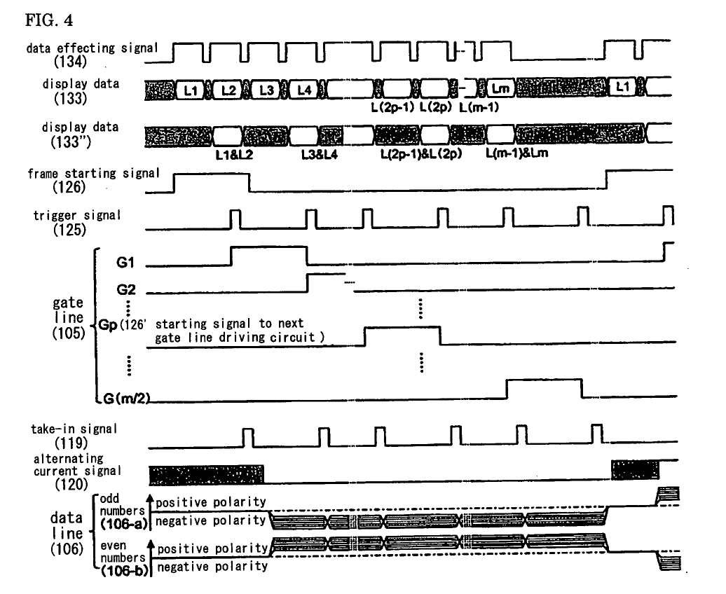

FIG. 4 shows a frame timing chart, and FIG. 5 shows a line timing chart. The operation in the first embodiment is described in reference to FIGS. 4 and 5.

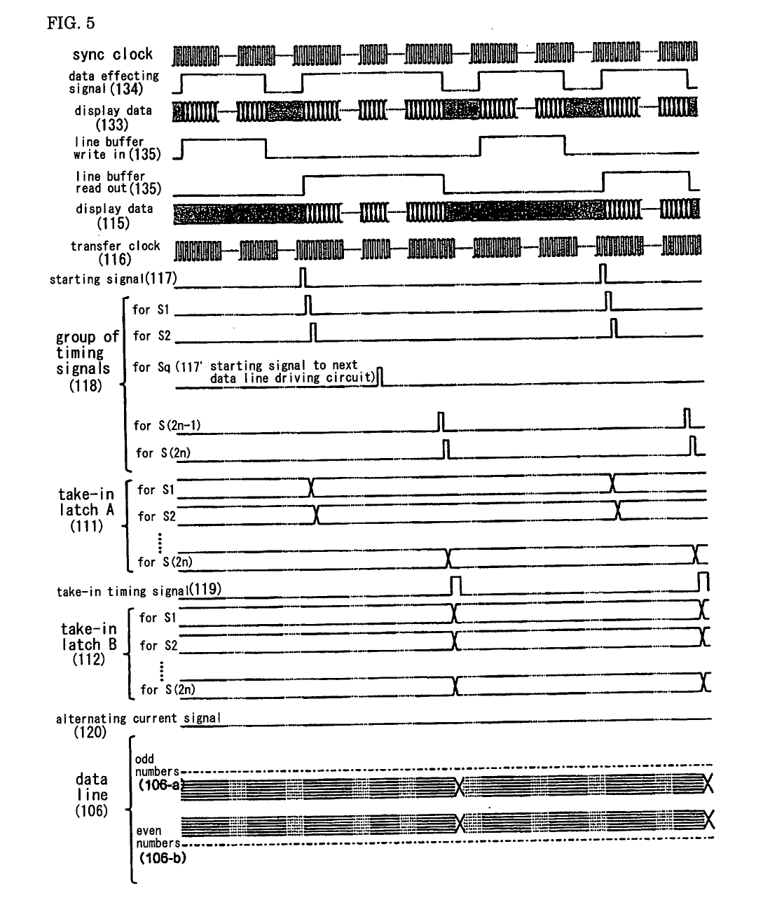

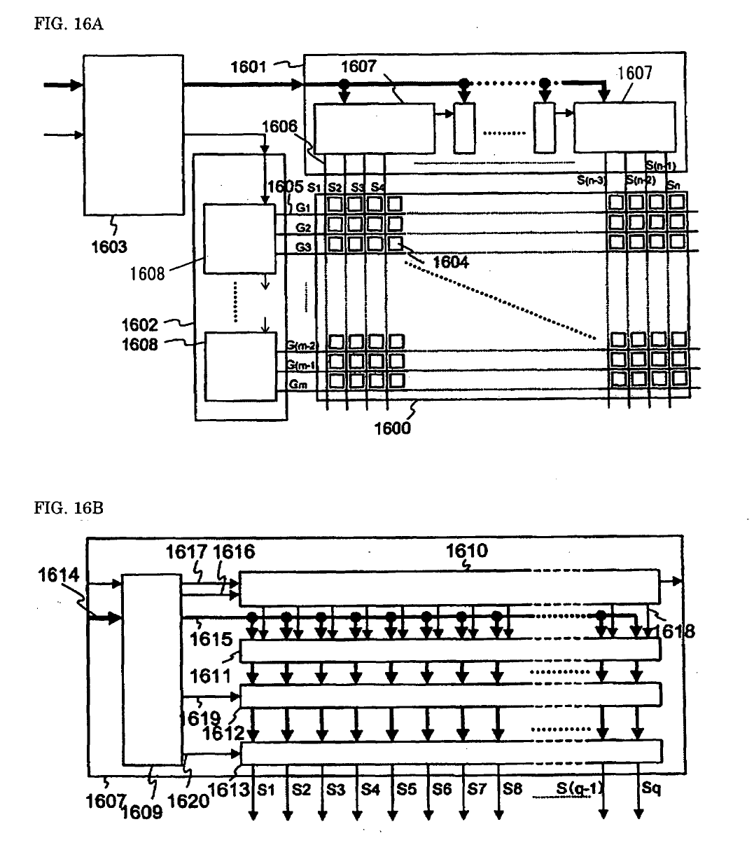

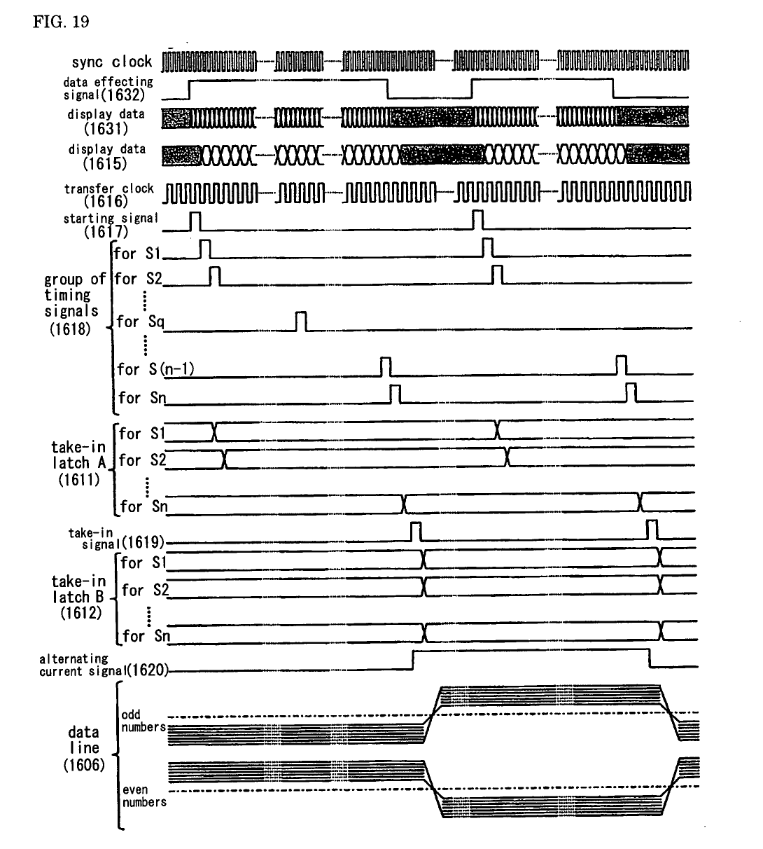

FIG. 1(d) shows an example of the configuration of the timing controlling portion 103. The timing controlling portion 103 is formed of a data processing portion 128 which is the same as in FIG. 16(d), in reference to which a conventional example is described, a timing generating portion 129 and a signal transmitting portion 130, in addition to a line buffer 131 and a multiplexer 132. When display data 133 and a timing signal 134 are inputted from an external system and the display data 133 is transferred from the upper portion of the display screen in sequence and the data processing portion 128 which carries out a signal process taking the properties and the configuration of the liquid crystal into account (for example an overdrive process and a process for adjusting the gradation properties) generates display data 133′ which is converted to a corresponding voltage in the data line driving portion 101. The display data 133 is inputted from an external system, for example, in the order: R pixels in the first row, G pixels in the first row, B pixels in the first row, R pixels in the second row, G pixels in the second row, B pixels in the second row . . . in series or in parallel. The odd lines (first line, third line . . . ) of gradation data 133′ are once stored in the line buffer 131 and data in the odd lines stored in accordance with the same timing as the even lines (second line, fourth line . . . ) is read out, and the multiplexer 132 realigns data for two lines in accordance with the alignment of pixels, so that display data 133″ to be processed by the data line driving portion is generated. The data format transferred simultaneously to two pieces of display data (data for R pixels, G pixels and B pixels), as in the prior art shown in FIG. 20, is transferred to the rear stage after the data for two lines is realigned together with the pixel alignment shown in FIG. 6. That is to say, data is realigned in the order: (1, 1) R pixel, (2, 1) R pixel, (2, 1) G pixel, (1, 1) G pixel, (1, 1) B pixel, (2, 1) B pixel, (2, 2) R pixel, (1, 2) R pixel, (1, 2) G pixel, (2, 2) G pixel, (2, 2) B pixel, (1, 2) B pixel . . . ) Here, (x, y) indicates the position (coordinates) of pixels. x indicates the position along the line of pixels (coordinate) and y indicates the position along the line of columns of pixels (coordinate).

The timing generating portion 129 generates from the timing signal 134 respective controlling signals 137 for the data line driving portion 101 and the gate line driving portion 102, signals 135 for controlling the line buffers (write-in signal, read-out signal, address signal and the like), and a signal 136 for controlling the multiplexer 132. The display data 133″ and the controlling signal 137 are converted in the signal transferring portion to a signal 114 in a transfer system of the data line driving portion 101 and a signal 124 in a transfer system of the gate line driving portion 102, which are then outputted.

The data line driving portion 101 is formed of a data line driving circuit 107 having a number of outputs q, so that a voltage in accordance with the gradation level of the display data is applied to 2n data lines S1, S2 . . . S(2n) of which the number is two times greater than the number of horizontal pixels. The present embodiment can be implemented using the same data line driving circuit IC as in the example of a conventional illiquid crystal display device, and the configuration uses IC's of which the total number of outputs is two times greater than the number of horizontal pixels (natural number of 2n÷q or greater).

FIG. 1(b) shows an example of the configuration of the data line driving circuit 107. The data line driving circuit 107 has the same configuration as in FIG. 16(b), in accordance with which a conventional example is described, and is formed of a signal receiving portion 109, a shift register 110, a take-in latch A (111), a take-in latch B (112) and a D/A converting portion 113. The signal receiving portion 109 receives display data and a timing signal (114), and the shift register 110 takes in a trigger signal 116 and a starting signal 117 which are in sync with the transfer of the display data 115, so that a group of timing signals 118 is generated by shifting the horizontal start signal 117 for each trigger signal 116. The shift register 110 outputs a start signal 117′ for the next data line driving circuit after transferring the signal for the output terminal, and the data line driving circuit in the latter stage receives a start signal 117′ from the data line driving circuit in the front stage and operates the shift register. The group of timing signals 118 outputted by the shift register 110 makes it so that the display data 115 is taken in by the take-in latch A (111) in sequence. The take-in latch A (111) is provided with a capacity for storing digital data for the output terminal. A number of data line drive circuits in the configuration store display data for two horizons, and a trigger signal 119 indicating the end thereof is provided from the outside, so that display data is collectively transferred from the take-in latch A (111) to the take-in latch B (112) this is converted to a voltage in accordance with the gradation level of the display data in the D/A converting portion 113 and outputted to the respective data lines (S1, S2 . . . Sq). The take-in latch B (112) is provided with the same capacity as the take-in latch A (111). Each data line (S1, S2 . . . Sq) outputs a positive or negative voltage to be applied to the liquid crystal in the D/A converting portion 113 in accordance with the alternating current signal 120 for the drive of the liquid crystal with the alternating current. In the case of the dot inverting drive, adjacent data lines output voltages of different polarities. In the case where the output from the data line driving circuit corresponds to conventional dot inversion in the pixel alignment of the present embodiment, dot inverting drive can be implemented only by inverting the frame period, without inverting the alternating current signal in a horizontal period. The polarity of the respective data lines is not inverted each time pixels are rewritten as in the prior art, and therefore, power loss can be reduced, and the power can be lowered.

The gate line driving portion 102 is formed of a gate line driving circuit 108 having a number of outputs p, and a voltage for turning ON/OFF the TFT's for writing the voltage outputted by the data line driving portion into pixel electrodes connected to the gate line and a voltage for turning OFF the TFT's connected to the gate line not for writing in the voltage outputted by other data line driving portions are supplied to m/2 gate lines G1, G2 . . . G(m/2) of which the number is ½ of the vertical pixels. The present embodiment can be implemented using a gate line driving circuit IC which is the same as in the example of a conventional illiquid crystal device, and the configuration uses IC's of which the total number of outputs is half of the number of vertical pixels (natural number of (m/2÷p or greater).

FIG. 1(c) shows an example of the configuration of a gate line driving circuit 108. The data line driving circuit 108 has the same configuration as in FIG. 16(c) as a conventional example, and formed of a signal receiving portion 121, a shift register 122 and a level shifter 123. The signal receiving portion 121 receives a timing signal 124, and the shift register 122 takes in a trigger signal 125 and a frame starting signal 126, and thus, a group of timing signals 127 gained by shifting the frame starting signal 126 for each trigger signal 125 is generated. The shift register 122 outputs a starting signal 126′ to the next gate line driving circuit after transferring the signal for the output terminal and the data line driving circuit in the rear stage receives a starting signal 126″ from the data line driving circuit in the front stage, and thus operates the shift register. The trigger signal 125 indicates horizontal timing for two horizontal periods starting from the vertical leading line. High signals and low signals of the group of timing signals 127 outputted from the shift register 122 are converted to a voltage for turning ON the gate line and a voltage for turning OFF the gate line, respectively, by the level shifter 123, and the resulting signals are outputted to the respective gate lines. All of the gate lines from the gate line G1 to the gate line G(m/2) are scanned for the ON voltage in sequence for every two horizontal periods using a number of gate line driving circuits in the configuration. The display data voltage in the corresponding position is applied to the pixel electrode for every two horizontal periods from the data line driving portion in accordance with the timing with which the gate line is turned ON for every two horizontal periods, and thus, one screen (one frame) is displayed.

In the first embodiment described above, the configuration using a conventional data line driving circuit IC and gate line driving circuit IC allows the write-in period during which a voltage for a panel with a high frame rate and high resolution of 120 Hz or higher, which is effective for reducing blurring of a moving image, is applied to a pixel electrode to be secured for two horizontal periods, which is two times greater than in the prior art, and thus, the image quality can be prevented from lowering. Though in the present embodiment, an example of a data line driving portion where pixels for two lines are connected to the same gate, and pixels for two lines are driven is shown, the number of lines is not limited to two, and configuration for a data line driving portion where pixels for three lines are connected to the same gate line so that pixels for three lines are driven simultaneously and a configuration for a data line driving portion where pixels for four lines are connected to the same gate so that pixels for four lines can be simultaneously driven can be introduced in accordance with the same idea, and thus, the number of lines connected to the same line can be increased, so that the write-in period, during which a voltage is applied to a pixel electrode, can further be increased.

The active matrix type liquid crystal display device and the driving method according to the second embodiment of the present invention are described in reference to FIGS. 1 and 7 to 9.

The configuration of the second embodiment is the same as that of the first embodiment, and is the configuration shown in FIG. 1(a), which is formed of a liquid crystal panel portion 100, a data line driving portion 101, a gate line driving portion 102 and a timing controlling portion 103. The liquid crystal panel portion 100 is provided with active elements, such as TFT's, as liquid crystal pixels 104 arranged in a matrix of n×m in a plane. The difference between the first embodiment and the second embodiment is in the connection between the TFT's of the pixels and the data lines.

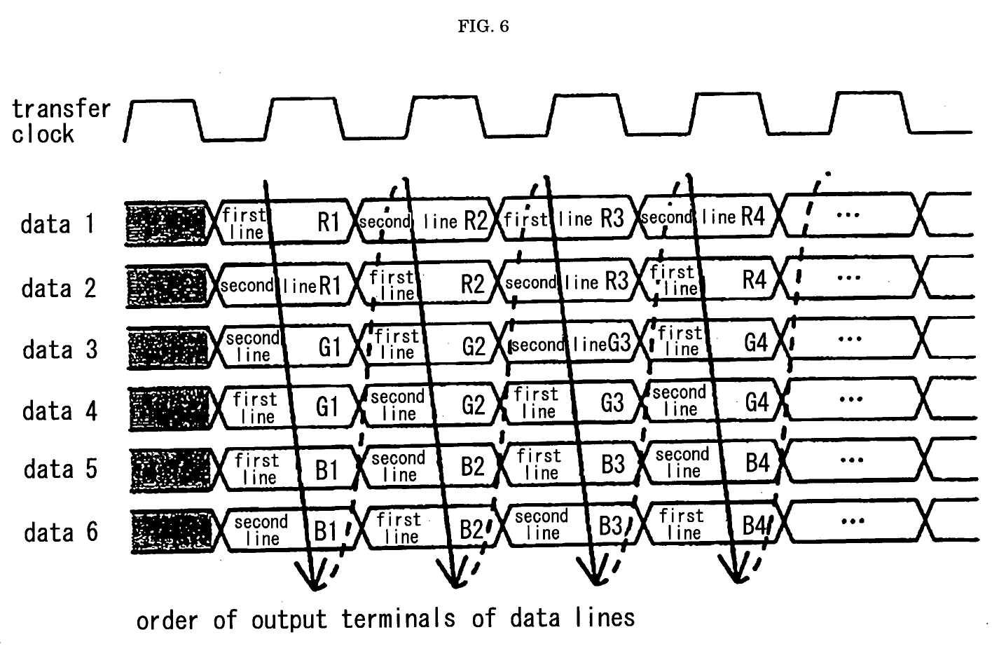

FIG. 7 shows the alignment of pixels in the second embodiment in detail. Pixels in the first line (704-1, 704-3, 704-5, 704-7 . . . ) are connected to odd data lines (704-1 is connected to the data line S1, 704-3 is connected to the data line S3, 704-5 is connected to the data line S5 and 704-7 is connected to the data line S7). Pixels in the second line connected to the same gate line G1 (704-2, 704-4, 704-6, 704-8 . . . ) are connected to different data lines from pixels in the first line (704-1, 704-3, 704-5, 704-7 . . . ), that is to say, even data lines (704-2 is connected to the data line S2, 704-4 is connected to the data line S4, 704-6 is connected to the data line S6 and 704-8 is connected to the data line S8). Thus, odd data lines are connected to pixels in odd lines and even data lines are connected to pixels in even lines. In the pixel configuration shown in FIG. 7, dot inverting drive where the image quality of the display is excellent can be implemented with a data line driving circuit IC which makes it possible to invert the polarity for every two outputs simply by inverting the frame period, without inverting the alternating current signal during the horizontal period for the voltage applied to the data lines.

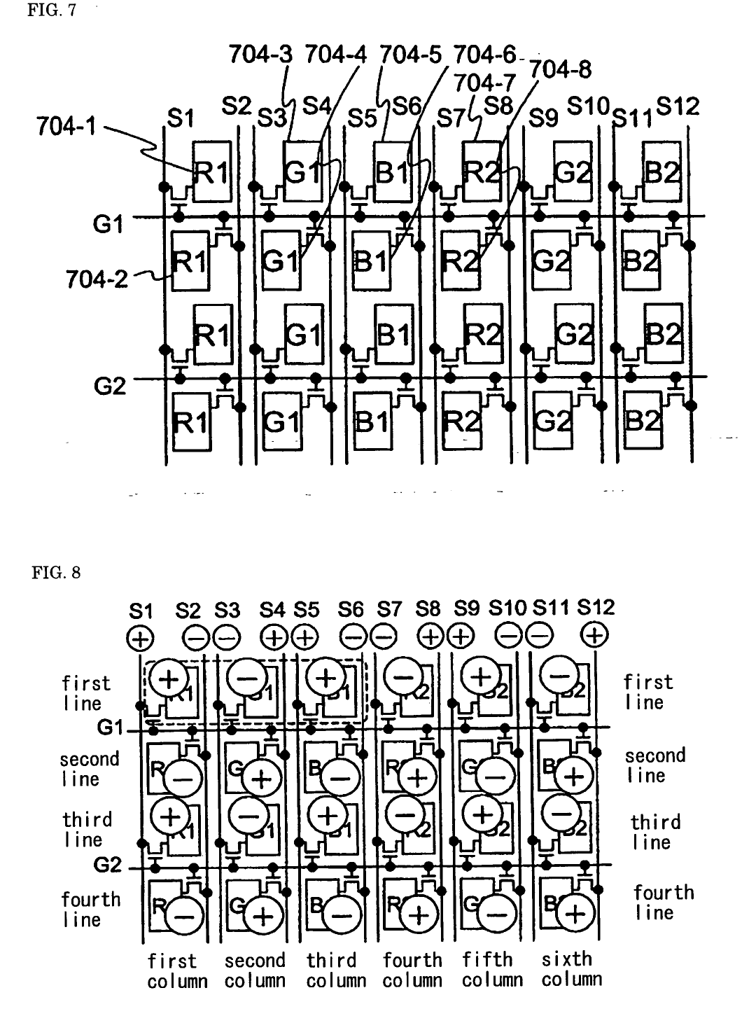

FIG. 8 shows the polarity of the voltage applied to each pixel in the second embodiment. A positive voltage is applied to data lines (S1, S4, S5, S8, S9 . . . ), a negative voltage is applied to even data lines (S2, S3, S6, S7 . . . ), and a voltage having the same polarity is applied during the frame period without inversion whenever the voltage for the data lines is updated. The polarity is inverted for every two outputs in the data lines, and therefore, data lines corresponding to adjacent pixels in each line have different polarities, and the polarity of the data lines connected to pixels in the same column (S1 and S2, S3 and S4 and the like) are different, and thus, dot inversion can be implemented.

In addition, in the second embodiment, in which the pixel alignment is different from in the first embodiment, a data realigning process which is suitable for aligning pixels by the multiplexer 132 in the timing controlling portion 103 is different from in the first embodiment.

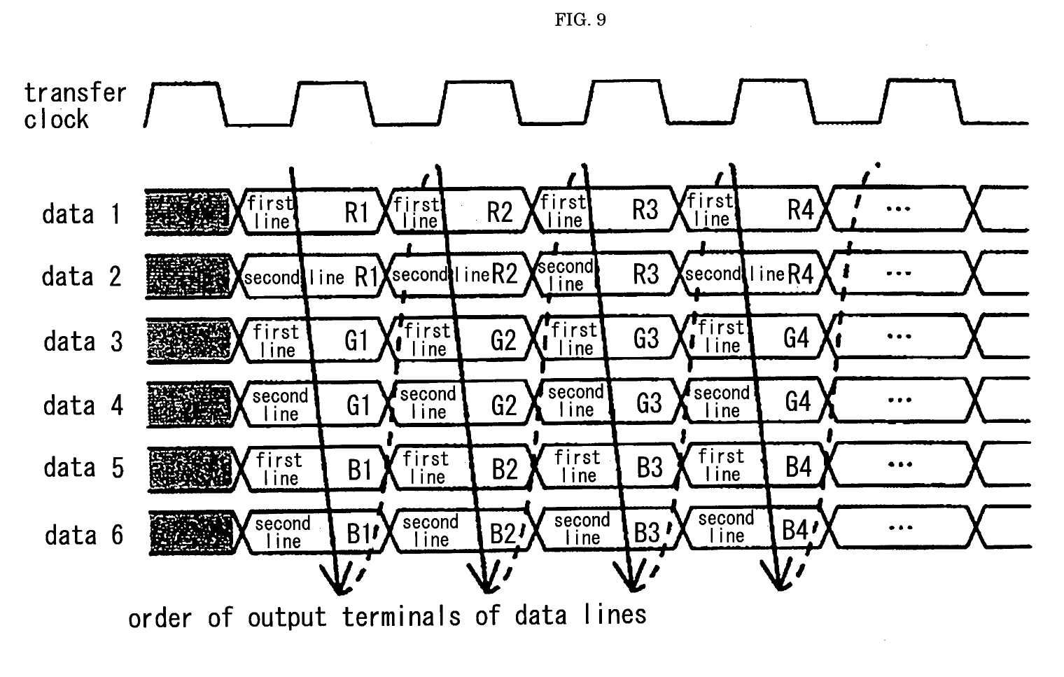

FIG. 9 shows a data realigning process according to the second embodiment. As shown in FIG. 9, data is realigned so that odd lines and even lines are outputted alternately. That is to say, data is realigned in the order: (1, 1) R pixel, (2, 1) R pixel, (1, 1) G pixel, (2, 1) G pixel, (1, 1) B pixel, (2, 1) B pixel, (1, 2) R pixel, (2, 2) R pixel, (1, 2) G pixel, (2, 2) G pixel, (1, 2) B pixel, (2, 2) B pixel . . . The configuration and operation of timing control portions other than the above described 103 are the same as in the first embodiment, and therefore, the description is omitted.

The configuration and operation of the data line driving portion 101 and the gate line driving circuit 108 are the same as in the first embodiment, and therefore, the description is omitted.

In the second embodiment, the configuration uses a conventional data line driving circuit IC and gate line driving circuit IC, as in the first embodiment, and thus, the write-in period during which a voltage is applied to the pixel electrode in the panel with a high frame rate and high resolution can be secured for two horizontal periods which are two times longer than in the prior art, and thus, the image quality can be prevented from lowering.

The active matrix type liquid crystal display device and driving method according to the third embodiment of the present invention are described in reference to FIGS. 1, 10 and 11.

The configuration of the third embodiment is the same as that of the first embodiment, which is shown in FIG. 1(a) and formed of a liquid crystal panel portion 100, a data line driving portion 101, a gate line driving portion 102 and a timing controlling portion 103. The liquid crystal panel portion 100 is provided with active elements, such as TFT's, as liquid crystal pixels 104 arranged in a matrix of n×m in a plane. In the third embodiment, the panel corresponds to display data for expressing RGBW, where white (W) is added in order to increase the efficiency of the brightness, unlike in display data expressed with the three primary colors of light: red (R), green (G) and blue (B), in the first and second embodiments. Here, the fourth pixels are not limited to white.

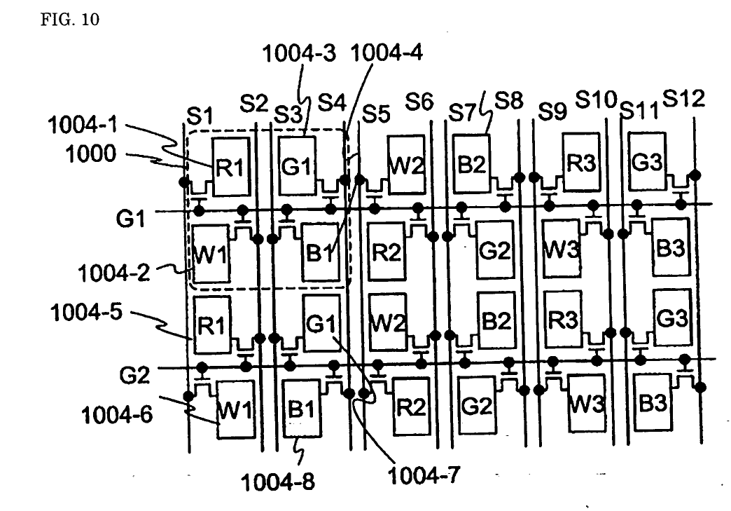

FIG. 10 shows an example of a panel with RGBW. In the example of FIG. 10, pixels in two rows×two columns which can easily increase the resolution correspond to RGBW so as to express one group of display data pixels 1000, where the number of vertical pixels is two times greater than the resolution for display. Therefore, though the period for the writing in of a voltage in the pixel electrode is shorter in the prior art, the same period for the writing in of a voltage which is the same as for the resolution of the display in the pixel electrode can be secured by connecting pixels corresponding to one group of display data pixels 1000 to the same gate lines, as shown in FIG. 10.

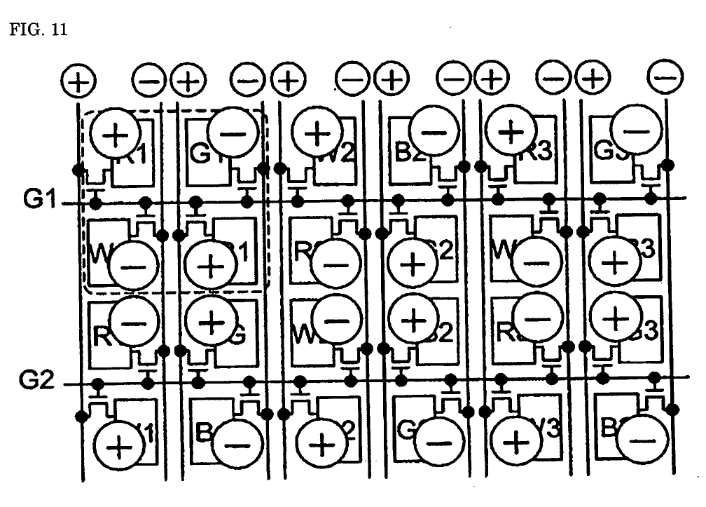

FIG. 11 shows the polarity of a voltage applied to each pixel in the third embodiment. FIG. 11 shows one possibility for a polarity pattern where the image quality deteriorates little due to the bias of the polarity. This can be implemented through pixel connection as in FIG. 10 using a data line driving circuit IC where dot inverting drive is possible only through inversion of the frame period, without inverting the alternating current signal during the horizontal period for the voltage applied to the data line. In reference to FIG. 10, pixels in odd lines (1004-1, 1004-3 . . . ) connected to odd gate lines (G1 . . . ) in odd pixel columns (1004-1 . . . ) are connected to odd data lines (1004-1 is connected to the data line S1) and pixels in even pixel columns (1004-3 . . . ) are connected to even data lies (1004-3 is connected to the data line S4). Pixels in even lines (1004-2, 1004-4 . . . ) connected to odd gate lines (G1 . . . ) are connected to a different data line from pixels in odd lines (1004-1, 1004-3 . . . ) connected to odd gate lines (G1 . . . ), and therefore, the odd pixel columns (1004-2 . . . ) are connected to even data lines (1004-2 is connected to the data line S2) and the even pixel columns (1004-4 . . . ) are connected to odd data line is (1004-4 is connected to the data line S3). In the pixels in odd lines (1004-5, 1004-7 . . . ) connected to the even gate lines (G2 . . . ), the odd pixel columns (1004-5 . . . ) are connected to even data lines (1004-5 is connected to the data line S2) and the even pixel lines (1004-7 . . . ) are connected to odd data lines (1004-7 is connected to the data line S3). Pixels in even lines (1004-6, 1004-8 . . . ) connected to even gate lines (G2 . . . ) are connected to a different data line from the pixels in odd lines (1004-5, 1004-7 . . . ) connected to even gate lines (G2 . . . ), and therefore, the odd pixel columns (1004-6 . . . ) are connected to odd data lines (1004-6 is connected to the data line S1) and the even pixel columns (1004-8 . . . ) are connected to even data lines (1004-8 is connected to the data line S4). The polarity pattern in FIG. 11, where the image quality deteriorates little due to the bias of the polarity, can be implemented with a data line driving circuit IC where dot inverting drive is possible only through inversion of the frame period, without inverting an alternating current signal during a horizontal period for the voltage applied to a data line.

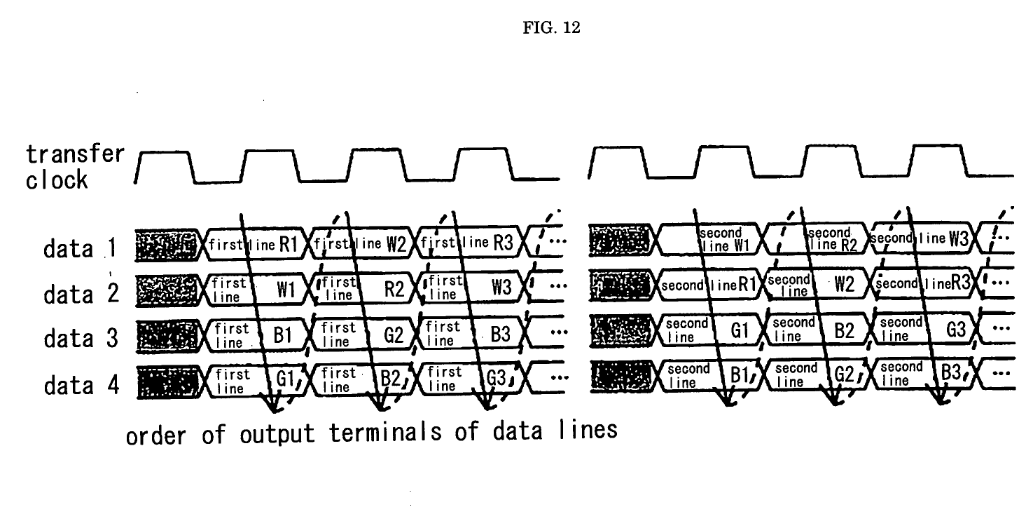

A data realigning process in accordance with the pixel alignment is required in the third embodiment, as in the first and second embodiments, and thus, the order of color data for each piece of data is realigned, so that odd lines and even lines have different outputs, as shown in FIG. 12. In addition, the line buffer used in conventional RGBW alignment of two rows×two columns for realignment becomes unnecessary, because the aligning is completed within the same line.

The active matrix type liquid crystal display device and driving method according to the fourth embodiment of the present invention are described in reference to FIGS. 1 and 13 to 15.

The configuration in the fourth embodiment is the same as in the first embodiment, which is the configuration in FIG. 1(a) and formed of a liquid crystal panel portion 100, a data line driving portion 101, a gate line driving portion 102 and a timing controlling portion 103. The connection of the pixels is the same as in the first embodiment, but the data line driving circuit 107 and the timing control portion 103 which form the data line driving portion 101 are different from in the fourth embodiment.

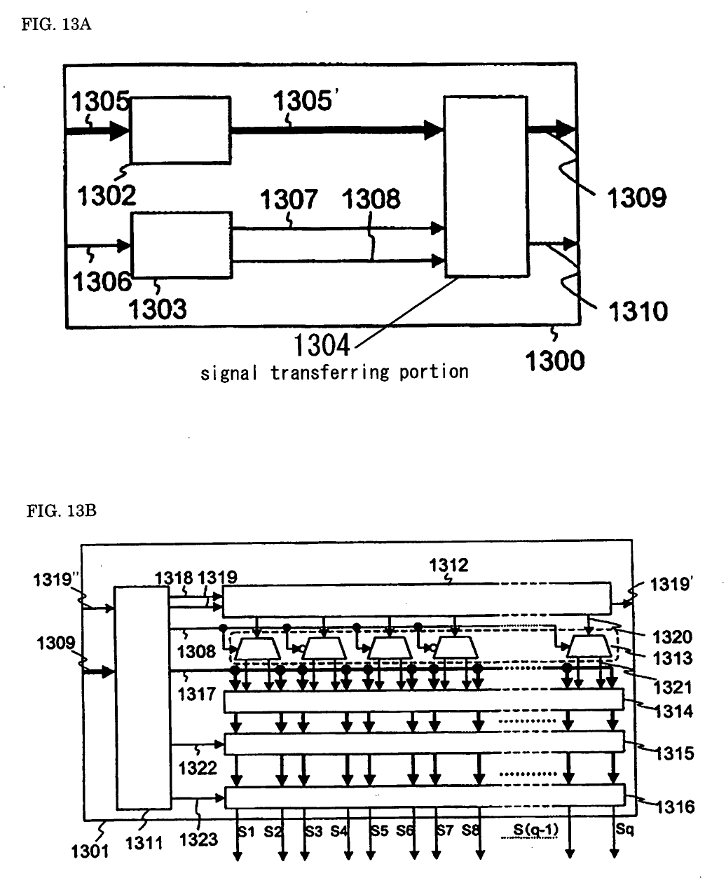

FIG. 13(a) shows the timing controlling portion 1300 in the fourth embodiment, and FIG. 13(a) shows the data line driving circuit 1301 in the third embodiment.

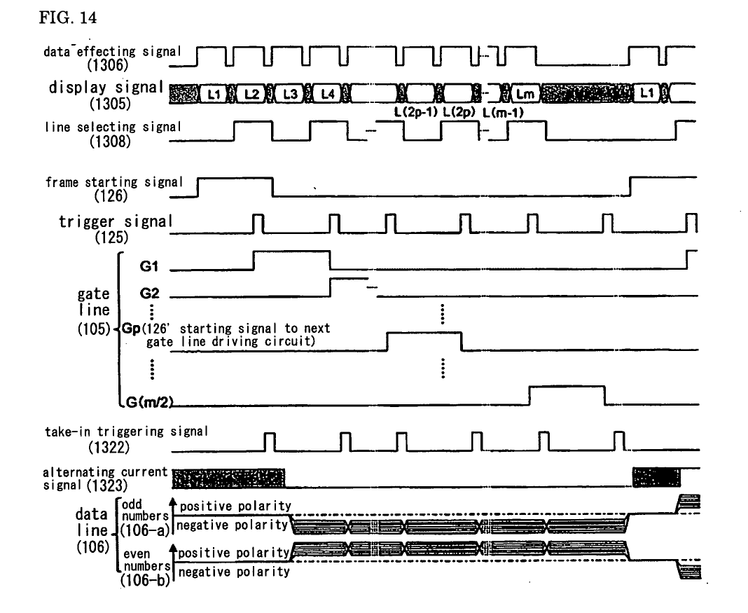

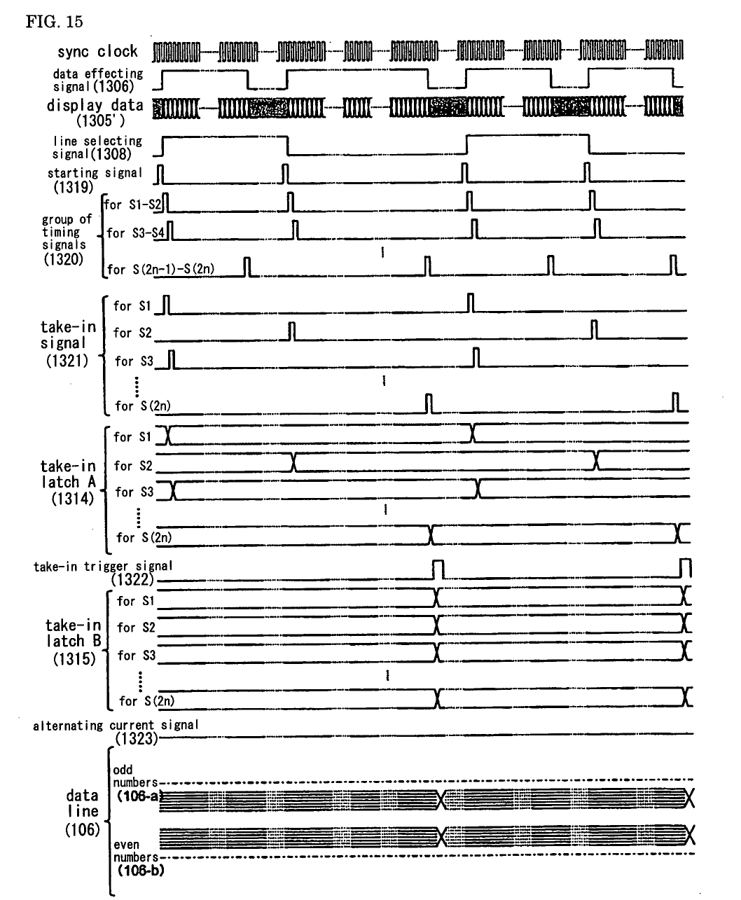

FIG. 14 shows a frame timing chart, and FIG. 15 shows a line timing chart. The operation of the fourth embodiment is described in reference to FIGS. 14 and 15.

The timing controlling portion 1300 has the same configuration as the conventional timing controlling portion, and is formed of a data processing portion 1302, a timing generating portion 1303 and a signal transmitting portion 1304. Display data 1305 and a timing signal 1306 are inputted from an external system, and the display data 1305 is transferred from the upper portion of the display screen in sequence, and gradation data 1305′ to be converted to a corresponding voltage in the data line driving portion 101 is generated in a data processing portion 1302 for carrying out signal process (for example an overdrive process and a process for adjusting the gradation properties) taking the properties and configuration of the liquid crystal into account.

The timing signal 1306 allows the timing generating portion 1303 to generate respective control signals 1307 for the data line driving portion 101 and the gate line driving portion 102, and a line selection signal 1308 which indicates odd lines and even lines used in the data line driving circuit 1301. The display data 1305′, the control signal 1307 and the line selection signal 1308 are converted to a signal 1309 in a transfer system for the data line driving portion 101 and a signal 1310 in a transfer system for the gate line driving portion 102 by the signal transferring portion, and then outputted.

As in the first embodiment, the data line driving portion 101 is formed of a data line driving circuit 1301 having a number of outputs q and applies a voltage corresponding to the gradation level of the display data to 2n data lines S1, S2 . . . S(2n) of which the number is two times greater than the number of horizontal pixels. The present embodiment can be implemented using the same data line driving circuit IC as in the example of a conventional illiquid crystal display device, and the configuration uses IC's of which the total number of outputs is two times greater than the number of horizontal pixels (natural number of 2n−q or higher). FIG. 13(b) shows an example of the configuration of the data line driving circuit 1301. The data line driving circuit 1301 is formed of a signal receiving portion 1311, a shift register 1312, a group of demultiplexers 1313, a take-in latch A (1314), a take-in latch B (1315) and a D/A converting portion 1316. The signal receiving portion 1311 receives display data and a timing signal (1309), takes in a trigger signal 1318 and a starting signal 1319 which are in sync with the transfer of the display data 1317 in the shift register 1312, and generates the group of timing signals 1320 by shifting the horizontal starting signal 1319 for each trigger signal 1318. The shift register 1312 outputs a starting signal 1319′ to the next data line driving circuit when signal transfer is carried out for ½ of the output terminal, and the data line driving circuit in the rear stage receives a starting signal 1319″ from the data line driving circuit in the front stage, so that the shift register is operated. The group of demultiplexers 1313 allows the line selection signal 1308 to designate take-in signals 1321 for the take-in latch A (1314) for making the group of timing signals 1320 from the shift register 1312 correspond to odd output terminals and for the take-in latch A (1314) corresponding to the even output terminals. The line selection signal 1308 is a signal indicating an odd line or an even line of the inputted display data, and switches respective demultiplexers 1313 so that display data is stored in the take-in latch A (1314) in accordance with the connection of the pixels. display data for two horizons is stored by a number of data line driving circuits in the configuration, and when a trigger signal 1322 which indicates the end thereof is provided from the outside, display data is collectively transferred from the take-in latch A (1314) to the take-in latch B (1315). This is converted to a voltage in accordance with the gradation level of the display data in the D/A converting portion 1316 and outputted to respective data liens (S1, S2 . . . Sq). The take-in latch B (1315) has the same capacity as the take-in latch A (1314). In the D/A converting portion 1316, the respective data lines (S1, S2 . . . Sq) output a positive or negative voltage to be applied to the liquid crystal in accordance with an alternating current signal 1323 for alternating current drive of the liquid crystal. In the case of dot inverting drive, voltages of different polarities are outputted from adjacent data lines.

The gate line driving portion 102 has the same configuration and operation as in the first embodiment, and thus, the description is omitted.

In the above described fourth embodiment, the write-in period during which a voltage is applied to pixel electrodes in a panel with a high frame rate and high resolution can be secured during two horizontal periods which are two times greater than in the prior art, as in the first embodiment, by adding a group of demultiplexers 1313 to the data line driving circuit, even without providing a line buffer in the timing controlling portion, and thus, the image quality can be prevented from lowering.

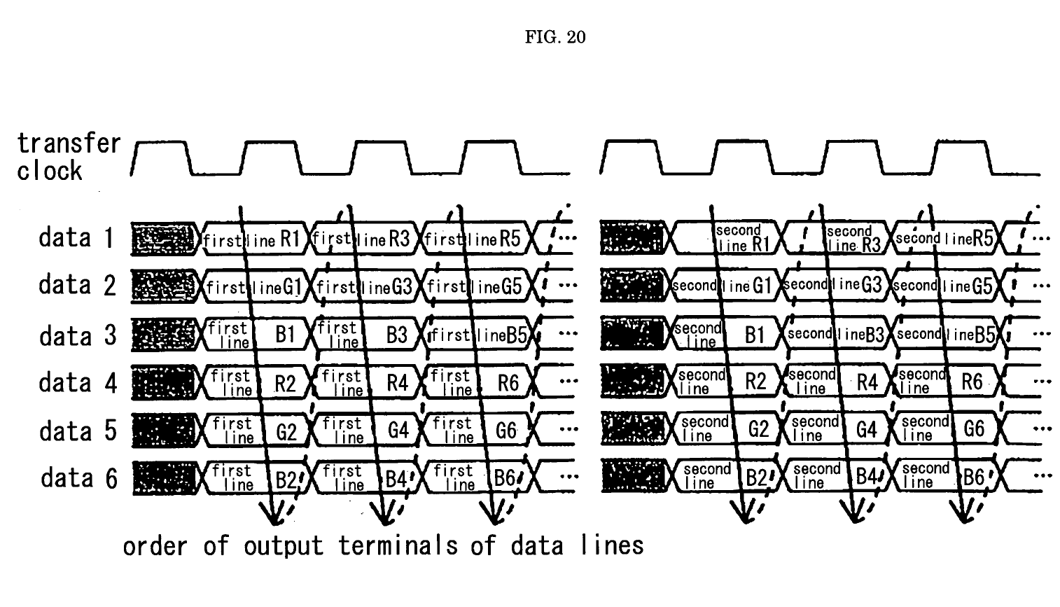

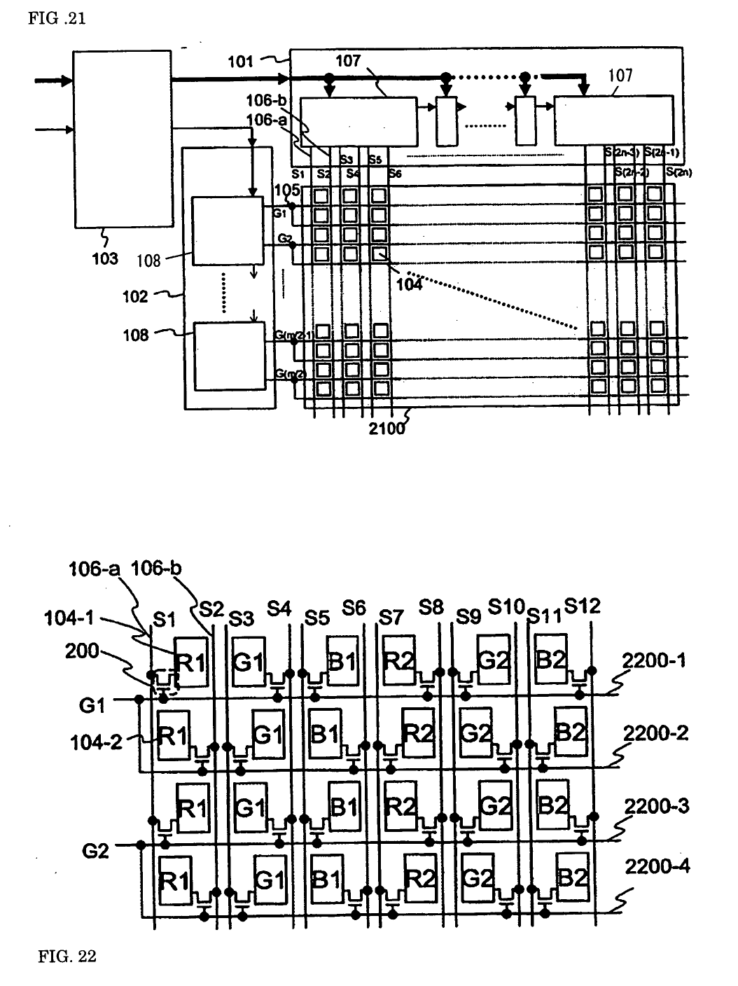

The active matrix type liquid crystal display device and driving method according to the fifth embodiment of the present invention are described in reference to FIGS. 21 and 22.

FIG. 21 shows the configuration of the fifth embodiment. The configuration of the fifth embodiment is the same as in the first embodiment, except that the configuration of the liquid crystal panel portion 2100 is different, and the operation is the same as in the first embodiment, and therefore, the description thereof is omitted.

FIG. 22 shows the alignment of pixels in the liquid crystal panel portion 2100 in detail. The electrodes for turning ON/OFF the respective active elements 200 are connected to the gate line 2201 shared by the group of pixels for one horizontal line, as in the liquid crystal panel portion in the prior art, and there are connections inside or outside the liquid crystal panel, so that the same gate controlling signal is applied to two adjacent gate lines 2200-1 and 2200-2, and these are connected to one output of the gate line driving portion. Likewise, 2200-3, 2200-4 . . . are connected to one output of the gate line driving portion for two gate lines of the liquid crystal panel. Parts other than the connection of the gate lines are the same as in the first embodiment, and two data lines 106 (106-a and 106-b) are provided to one vertical pixel column and electrodes for supplying a data voltage for two pixels (104-1 and 104-2) connected to the same gate line G1 and aligned in the vertical direction are connected to different data lines (106-a and 106-b). At this time, the even pixel column of pixels in the same line uniformly connects data lines to adjacent even data lines or odd data lines, and odd pixel columns are connected to odd data lines when the even pixel columns are even data lines and connected to adjacent even data lines when the even pixel columns are odd data lines.

In the configuration of the pixels shown in FIG. 22, as in the first embodiment, voltages of the same polarity are applied during the frame period without inversion whenever the voltage for the data line is updated as in the prior art. The data lines connected to two adjacent pixels are odd data lines and even data lines above, beneath, left and right. In an example of the pixel in the second row, second line, the pixel in the second row, second line is connected to S3 and an odd data line. Pixels above and beneath are connected to S4, the pixel on the left is connected to S2, the pixel on the right is connected to S6, and the adjacent pixels are connected to even data lines, and thus, dot inversion is implemented.

In the fifth embodiment, as in the first embodiment, the configuration uses a conventional data line driving circuit IC and a gate line driving circuit IC, the write-in period during which a voltage is applied to a pixel electrode in a panel with a high frame rate and high resolution of 120 Hz or higher can be secured for two horizontal periods, which is two times greater than in the prior art, and thus, the image quality can be prevented from lowering.

While we have shown and described several embodiments in accordance with our invention, it should be understood that disclosed embodiments are susceptible to change and modification without departing from the scope of the invention. Therefore, we do not intend to be bound by the details shown and described herein but intend to cover all such changes and modifications within the ambit of the appended claims.

What is claimed is:

1. A display device, comprising:
a display panel where a number of data lines extending in the direction of the columns and a number of gate lines extending in the direction of the rows are wired in a matrix, and a number of pixels connected to said data lines and said gate lines are aligned in a matrix;
a first drive circuit for outputting a display signal in accordance with display data to a data line; and
a second drive circuit for outputting a selection signal for selecting a pixel to receive said display signal to a gate line, characterized in that pixels in two adjacent rows in a same column are connected to different data lines and connected to a same gate line.

2. The display device according to claim 1, characterized in that pixels in a same column in every N rows (N is an integer of 1 or greater) are connected to a same data line.

3. The display device according to claim 1, characterized in that
the number of said data lines is two times or greater than the number of pixels in the direction of the rows, and
the number of said gate lines is ½ times or less the number of pixels in the direction of the columns.

4. The display device according to claim 1, characterized by further comprising a control circuit which realigns the display data inputted in series or parallel in the order of the display data corresponding to pixels for one row in the first row from among the display data corresponding to pixels in two adjacent rows and the display data corresponding to pixels for one row in the second row from among the display data corresponding to pixels in two adjacent rows so that the display data corresponding to pixels in a same column in the first and second rows, which are two adjacent rows, can be outputted in sequence, and outputs the result to said first drive circuit.

5. The display device according to claim 1, characterized in that
the first and fourth data lines from among four adjacent data lines are connected to pixels aligned in either odd rows or even rows from among pixels aligned in a same column, and
the second and third data lines from among four adjacent data lines are connected to pixels aligned in the other odd rows or even rows from among pixels aligned in a same column.

6. The display device according to claim 5, characterized in that
said number of pixels include red (R) pixels, green (G) pixels and blue (B) pixels, and
the display device further comprises a control circuit which realigns the display data to be inputted in series or parallel in the order of the display data RGB corresponding to pixels for one row in the first row from among the display data corresponding to pixels in two adjacent rows and the display data RGB corresponding to pixels for one row in the second row from among the display data corresponding to pixels in two adjacent rows in the order of R in the first row, R in the second row, G in the second row, G in the first row, B in the first row and B in the second row or in the order of R in the second row, R in the first row, G in the first row, G in the second row, B in the second row and B in the first row, and outputs the result to said first drive circuit.

7. The display device according to claim 5, characterized in that said first drive circuit
supplies a display signal with a positive polarity to the first data line from among two adjacent data lines during a period of one frame or more and a display signal with a negative polarity to the second data line from among the two adjacent data lines, and
supplies a display signal with a negative polarity to the first data line from among two adjacent data lines during the next period of one frame or more and a display signal with a positive polarity to the second data line from among the two adjacent data lines.

8. The display device according to claim 1, characterized in that
the first data line from among two adjacent data lines is connected to pixels arranged in either odd rows or even rows from among pixels arranged in a same column; and
the second data line from among two adjacent data lines is connected to pixels arranged in the other odd rows or even rows from among pixels arranged in a same column.

9. The display device according to claim 8, characterized in that
said number of pixels include red (R) pixels, green (G) pixels and blue (B) pixels, and
the display device further comprises a control circuit which realigns the display data to be inputted in series or parallel in the order of the display data RGB corresponding to pixels for one row in the first row from among the display data corresponding to pixels in two adjacent rows and the display data RGB corresponding to pixels for one row in the second row from among the display data corresponding to pixels in two adjacent rows in the order of R in the first row, R in the second row, G in the first row, G in the second row, B in the first row and B in the second row, and outputs the result to said first drive circuit.

10. The display device according to claim 8, characterized in that said first drive circuit
supplies a display signal with a positive polarity to the first and fourth data lines from among four adjacent data lines during a period of one frame or more and supplies a display signal with a negative polarity to the second and third data lines from among four adjacent data lines, and
supplies a display signal with a negative polarity to the first and fourth data lines from among four adjacent data lines during the next period of one frame or more and supplies a display signal with a positive polarity to the second and third data lines from among four adjacent data lines.

11. The display device according to claim 1, characterized in that
the first and fourth data lines from among four adjacent data lines are connected to pixels arranged in one pair from among a pair of pixels in the first and fourth rows and a pair of pixels in the second and third rows from among pixels arranged in four adjacent rows in a same column, and
the second and third data lines from among four adjacent data lines are connected to pixels arranged in the other pair from among the pair of pixels in the first and fourth rows and the pair of pixels in the second and third rows from among pixels arranged in the four adjacent rows in the same column.

12. The display device according to claim 11, characterized in that said first drive circuit
supplies a display signal with a positive polarity to the first data line from among two adjacent data lines during a period of one frame or more and a display signal with a negative polarity to the second data line from among the two adjacent data lines, and
supplies a display signal with a negative polarity to the first data line from among two adjacent data lines during the next period of one frame or more and a display signal with a positive polarity to the second data line from among the two adjacent data lines.

13. The display device according to claim 1, characterized in that
said first drive circuit comprises a memory circuit for storing display data corresponding to pixels in two rows, and
the display device comprises a control circuit which sequentially inputs the display data corresponding to pixels for one row in the first row from among the display data corresponding to pixels in two adjacent rows and the display data corresponding to pixels for one row in the second row from among the display data corresponding to pixels in two adjacent rows in series or parallel, in this order, and realigns the display data corresponding to the pixels in the first row from among two adjacent rows and the display data corresponding to the pixels in the second row at the time of the writing in of said memory circuit.

14. The display device according to claim 13, characterized in that said first drive circuit supplies a display signal with a positive polarity to the first data line from among two adjacent data lines during a period of one frame or more and a display signal with a negative polarity to the second data line from among the two adjacent data lines, and
supplies a display signal with a negative polarity to the first data line from among two adjacent data lines during the next period of one frame or more and a display signal with a positive polarity to the second data line from among the two adjacent data lines.

15. A display device, comprising:
a display panel where a number of data lines extending in the direction of the columns and a number of gate lines extending in the direction of the rows are wired in a matrix, and a number of pixels connected to said data lines and said gate lines are aligned in a matrix;
a first drive circuit for outputting a display signal in accordance with display data to a data line; and
a second drive circuit for outputting a selection signal for selecting a pixel to receive said display signal to a gate line, characterized in that
pixels in two adjacent rows in a same column are connected to different data lines and connected to different gate lines, and
said second drive circuit selects pixels in two adjacent rows in said same column using the respective gate lines and the respective selection signals with chronological overlapping.

16. The display device according to claim 15, characterized by further comprising a control circuit which realigns the display data inputted in series or parallel in the order of the display data corresponding to pixels for one row in the first row from among the display data corresponding to pixels in two adjacent rows and the display data corresponding to pixels for one row in the second row from among the display data corresponding to pixels in two adjacent rows so that the display data corresponding to pixels in a same column in the first and second rows, which are two adjacent rows, can be outputted in sequence, and outputs the result to said first drive circuit.

17. The display device according to claim 15, characterized in that
the first and fourth data lines from among four adjacent data lines are connected to pixels aligned in either odd rows or even rows from among pixels aligned in a same column, and
the second and third data lines from among four adjacent data lines are connected to pixels aligned in the other odd rows or even rows from among pixels aligned in a same column.

18. The display device according to claim 17, characterized in that
said number of pixels include red (R) pixels, green (G) pixels and blue (B) pixels, and
the display device further comprises a control circuit which realigns the display data to be inputted in series or parallel in the order of the display data RGB corresponding to pixels for one row in the first row from among the display data corresponding to pixels in two adjacent rows and the display data RGB corresponding to pixels for one row in the second row from among the display data corresponding to pixels in two adjacent rows in the order of R in the first row, R in the second row, G in the second row, G in the first row, B in the first row and B in the second row or in the order of R in the second row, R in the first row, G in the first row, G in the second row, B in the second row and B in the first row, and outputs the result to said first drive circuit.

19. The display device according to claim 17, characterized in that said first drive circuit
supplies a display signal with a positive polarity to the first data line from among two adjacent data lines during a period of one frame or more and a display signal with a negative polarity to the second data line from among the two adjacent data lines, and
supplies a display signal with a negative polarity to the first data line from among two adjacent data lines during the next period of one frame or more and a display signal with a positive polarity to the second data line from among the two adjacent data lines.
